(19) United States
(12) Patent Application Publication
(10) Pub. No.: US 2025/0115175 A1
(43) Pub. Date: Apr. 10, 2025

(54) Sleeve Device for a Headrest

(71) Applicant: Illinois Tool Works Inc., Glenview, IL (US)

(72) Inventors: Jorge Adolfo MIRANDA NIETO, Barcelona (ES); Albert MORENO SERRA, L’Amettla del Vallès (ES); David MONTES COBO, Sabadell (ES)

(21) Appl. No.: 18/906,497

(22) Filed: Oct. 4, 2024

(30) Foreign Application Priority Data
Oct. 6, 2023 (EP) 23 202 141.0

(51) Int. Cl. B60N 2/897

(52) U.S. Cl. CPC B60N 2/897

(57) ABSTRACT

The disclosure relates to a sleeve apparatus for a headrest. The sleeve apparatus includes a sleeve body for insertion into a frame of a vehicle seat. During use, the sleeve body is inserted into the frame of the vehicle seat and is generally located therein. The sleeve body includes a tubular wall defining an internal axial passageway having an inner surface configured to receive a rod of a headrest. The tubular wall includes an outer surface opposite the inner surface of the tubular wall. The tubular wall includes at least two recesses extending in a longitudinal direction of the tubular wall between the outer surface and the inner surface. The recesses define a deformable part of the tubular wall of the sleeve apparatus.

### RELATED APPLICATIONS

The present application claims the benefit of European Patent Application No. 23 202 141.0, filed Oct. 6, 2023, titled “Sleeve Device for a Headrest,” the contents of which are hereby incorporated by reference.

### BACKGROUND

Headrests attached to the backrests of vehicle seats typically have two rods arranged parallel to one another, which extend from a lower end of the headrest. The spaced-apart rods are housed in sleeves attached to the frame of the vehicle seatback. The headrest rods are often bent in a U shape. The bridge of the U shape is located inside the headrest.

Known sleeve apparatuses for headrests consist of a sleeve body inserted into an opening in a frame of a vehicle seat. The sleeve body comprises an internal axial passageway for receiving a rod of the headrest. The inner axial passageway comprises an inner wall designed to engage with the rods of the headrest.

The known sleeve apparatus is arranged in a frame of the seatback and is therefore subject to tolerances. The sleeve apparatus and the U-shaped rods are also subject to tolerances due to their separate manufacture. The spacing between the rods of the headrest can vary, so that the rods, when this spacing does not match the axial spacing of the sleeve apparatuses, may need to be slightly bent away from or towards one another. However, as a result, the rods of the headrest are no longer exactly parallel. In addition to the problems related to the distance between the rods, noise problems also arise when there are gaps between the outer diameter of the metal rods and the diameter of the inner axial passageway of the sleeve apparatuses. One solution to this problem would be to construct sleeves and rods to fit closely together with no gap between them. In such a case, however, the metal rods would no longer slide smoothly along the sleeves, which would result in a fixed headrest that could no longer be adjusted to the user's body size.

To achieve optimum cooperation of the sleeve apparatus and the rod as well as the sleeve apparatus and the frame, sleeve apparatuses are typically manufactured in a narrow tolerance range. Nevertheless, these components still experience noise problems such as humming, squeaking, and rattling and difficulty adjusting the headrest, which can be bothersome and uncomfortable for the user.

In view of the above statements, it is desirable to achieve a good balance between the noise problems known as humming, squeaking, and rattling and a smooth movement of the headrest with an appropriate amount of sliding effort for the user.

### SUMMARY

The present disclosure relates generally to a sleeve apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a schematic side view of a sleeve apparatus according to an embodiment of the present disclosure.

FIG. 2 illustrates a further side view of the embodiment shown in FIG. 1.

FIG. 3 illustrates an enlarged cross-section along line B-B in FIG. 2.

FIG. 4 illustrates a schematic illustration of a portion of the sleeve apparatus according to FIG. 1, having ribs in the transverse direction.

FIG. 5 illustrates a schematic illustration of a portion of the sleeve apparatus according to FIG. 1, having ribs in the longitudinal direction.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The term “recess” is understood to mean a continuous opening in the tubular wall.

The present disclosure relates to a sleeve apparatus for a headrest and a vehicle seat having such a sleeve apparatus. The present disclosure attempts to solve or at least mitigate some of the problems associated with the prior art. In particular, the present disclosure aims to provide a sleeve apparatus that can reduce noise problems while being easy to manufacture. The aforementioned problem addressed by the present disclosure is solved by the sleeve apparatuses of independent claim 1 and the seat of claim 10. Further embodiments are disclosed in the attached dependent claims.

According to a first aspect of the disclosure, a sleeve apparatus for a headrest is provided, comprising a sleeve body for insertion into a frame of a vehicle seat, wherein, during use, the sleeve body is inserted into the frame of the vehicle seat and is generally located therein. The sleeve body comprises a tubular wall defining an internal axial passageway having an inner surface configured to receive a rod of a headrest. The tubular wall comprises an outer surface opposite the inner surface of the tubular wall. The tubular wall comprises at least two recesses extending in a longitudinal direction of the tubular wall between the outer surface and the inner surface, wherein the recesses define a deformable part of the tubular wall of the sleeve apparatus.

The use of parallel recesses to define a deformable part has several advantages. First, the deformable part of the sleeve apparatus can be used in order to ensure a close contact between the sleeve and the metal frame of the vehicle seat. At the same time, the deformable part can be used in order to work closely with the rods of the headrest to avoid undesirable noises due to vibrations. Finally, the use of two recesses to define a deformable part allows for easy manufacture of the sleeve apparatus of the present disclosure. For example, the sleeve apparatus can be a one-piece injection-molded part and therefore does not require any other materials than the plastic of the sleeve body. Advantageously, the deformable part can be elastically deformed, e.g., pushed into an inner axial passageway of the sleeve body when the sleeve body is inserted into the frame of the vehicle seat.

The sleeve apparatus can comprise a head portion in an upper region and the sleeve body in a region that is connected underneath the former. The sleeve body is also called the main body. The head portion is arranged on an upper (proximal) end of the sleeve body. The sleeve body extends in a lower (distal) direction away from the head part and is suitable for being received in a corresponding opening of the frame of a vehicle seat. During use, the head part acts as an end stop for the insertion of the sleeve apparatus into the opening of the vehicle seat.

According to a further embodiment, the two recesses are configured to be substantially parallel to one another. Thus, the tubular wall comprises the at least two substantially parallel recesses extending in a longitudinal direction of the tubular wall between the outer surface and the inner surface. In such an embodiment, the deformable part is configured as a preferably axial strip defined by the two recesses. In some embodiments, however, it can also be possible to provide the recesses at an angle to one another and to the longitudinal direction of the sleeve body. In such a case, the deformable part can be substantially trapezoidal. Through the respective selection of the arrangement of the recesses, the deformation properties of the deformable part can be adjusted.

According to a further embodiment, the tubular wall comprises at least one groove extending substantially perpendicular to the parallel recesses, wherein the groove connects the recesses to one another. It can be provided that the groove extends between the parallel or angular recesses at the distal (lower) ends of the recesses. The groove improves the deformability of the deformable part of the tubular wall, facilitates insertion of the sleeve apparatus, and provides a snug fit between the inner axial passageway and the headrest rods.

In some examples, the groove is a part of the tubular wall having a reduced wall thickness. In other words, the groove is not a further recess. Rather, the groove provides for a thinner wall portion connecting the two parallel recesses to one another. The groove can extend in the circumferential direction of the outer surface of the sleeve body between the parallel recesses. In this embodiment, the groove is formed at the lower end of the deformable part of the sleeve body. In an alternative embodiment, a third recess can be arranged between the parallel recesses, e.g., instead of the groove. If a third recess is provided in place of the groove having a reduced wall thickness, the deformable parts can be considered as a boom extending in the longitudinal direction of the sleeve apparatus. In this embodiment, the third recess connects the two longitudinally formed recesses to one another. In this case, the three recesses in contact with one another can also be referred to as a U-shaped recess.

According to a further embodiment, the two recesses are L-shaped. It can be provided that the L-shaped peaks of the two recesses are conjugate with one another and/or that the L-shaped peaks are configured in the lower (distal) region of the recesses. The preferably lower connection of the deformable part to the sleeve body is thus narrower than the deformable part, whereby the deformability can be adjusted in a targeted manner. A narrow lower connection provides for an easy deformation, wherein a wider lower joint requires greater force for deformation. It can be provided that the L-shaped peaks arranged opposite one another are arranged in the region of the groove described above.

According to a further embodiment, the sleeve apparatus is a one-piece injection-molded part. According to this embodiment, the sleeve apparatus of the present disclosure is particularly easy to manufacture. Due to the weakening regions defined by the recesses and/or the groove, a deformable part can be produced without the need for further materials other than the plastic of the base body of the sleeve apparatus. By contrast, it can be contemplated to provide deformable parts made of materials that are more flexible than the plastic of the sleeve body. In the exemplary embodiment, this is not necessary, and the sleeve is not comprised of other materials, e.g., overmolded parts.

According to a further embodiment, the deformable part comprises a first thickened portion configured to contact the frame of the vehicle seat. The first thickened portion is arranged on the deformable part in a location that is configured to contact the frame of the vehicle seat. In other words, the thickened portion of the deformable part is a region of the sleeve apparatus that has a larger diameter than the diameter of the outer wall of the sleeve body of the sleeve apparatus. The outer diameter of the sleeve apparatus along the first thickened portion can be slightly smaller than the inner diameter of the frame of the vehicle seat. Accordingly, when the sleeve apparatus according to this embodiment is inserted into the opening of the seat frame, the deformable part is forced towards the inner axial passageway when the thickened portion contacts the frame of the vehicle seat.

According to a further embodiment, the deformable part comprises a projection extending across the outer surface of the tubular wall, wherein the projection defines a latch that is suitable for securing the sleeve apparatus in the frame of the vehicle seat, in particular in a longitudinal direction of the sleeve. The projection can be arranged at a distal (lower) end of the deformable part, e.g., in the vicinity of a circumferential groove as mentioned above. In some embodiments, the projection can have a diameter that is greater than the diameter of the thickening portion. Because the projection is arranged on the deformable part, the projection can be pushed towards the inner axial passageway when the sleeve apparatus is inserted into the opening of the seat frame and snaps back as soon as the sleeve apparatus is fully inserted. The projection can have a shoulder portion that is designed to engage into a recess of the seat frame when the sleeve is fully inserted. The catch defined by the projection ensures that the sleeve apparatus cannot be accidentally pulled out of the opening of the seat, e.g., when adjusting the height of the headrest, i.e., when the rods are pulled out of the internal passageway of the sleeve apparatus. It follows that the deformable part not only acts to dampen noise, but also facilitates the secure fastening of the sleeve apparatus in the frame of the vehicle seat.

According to a further embodiment, the projection is substantially ramp-like in form, and its thickness increases gradually from a distal end of the deformable part towards a proximal end of the deformable part, wherein the projection defines a shoulder portion for engagement into a recess of the frame of the vehicle seat when it is in use. Due to the ramp-like character of the projection, the sleeve apparatus can be inserted smoothly into the opening of the vehicle seat without a sudden increase in resistance. During insertion, the deformable part is gradually bent towards the inner axial passageway when the frame of the vehicle seat moves over the outer surface of the sleeve apparatus. As soon as the sleeve apparatus is fully inserted into the vehicle seat, the deformable part snaps back, so that the projection is now arranged in a recess of the frame of the vehicle seat, and the shoulder acts as an end stop that prevents a longitudinal movement of the sleeve apparatus in relation to the vehicle seat.

According to a further embodiment, the deformable part comprises a protruding portion, preferably at the lower (distal) region of the deformable part. The protruding portion is arranged on the deformable part at a location that is configured to contact a frame of a vehicle seat. The protruding portion is preferably configured to extend beyond the outer surface when a rod of a headrest is arranged in the sleeve apparatus and cooperates with a frame of a vehicle seat. The deformable part with the protruding portion thus forms a contact region between the rod and the frame of the vehicle seat, thereby suppressing noise problems such as humming, squeaking, and rattling, while simultaneously minimizing difficulty in adjusting the headrest through the arrangement of the protruding portion in the lower region of the sleeve apparatus. The deformable part can be formed in lieu of the thickened portion described above.

It can be contemplated that the protruding portion may not extend beyond the outer surface when a rod of a headrest is not arranged in the sleeve apparatus. This can be achieved in that the protruding portion is arranged on the deformable part in an inwardly offset manner, preferably in a groove in the deformable part.

According to a further embodiment, the protruding portion is formed integrally in or on the deformable part, and preferably the sleeve apparatus having the deformable part with the protruding portion is a one-piece injection-molded part. According to this embodiment, the sleeve apparatus of the present disclosure is particularly easy to manufacture. Due to the integral deformable part having the protruding portion, a flexible contact region can be produced without the need for further materials other than the plastic of the base body of the sleeve apparatus.

It can be provided that the protruding portion is configured as a stand-away annulus having an opening, preferably as a semicircular annular segment or three-quarter annular segment. The opening can be configured as a slot in the stand-away annulus or the missing annular segment. In a mounted arrangement of the sleeve apparatus, the annulus with the opening is deformed. This is achieved by a rod of a headrest in the sleeve apparatus and a frame of a vehicle seat from the outside, whereby the stand-away annulus is compressed and thus assumes an elliptical shape. Advantageously, the result is that, due to the choice of the size of the annulus and/or the opening, the contact region and the pressure between the rod and the frame can be adjusted in a targeted manner.

According to a further embodiment, the opening is configured outwardly, i.e., orthogonally to the axis of the axial passageway. The stand-away annulus can be shape-retaining and elastic and acts as a contact region between a rod of a headrest and a frame of a vehicle seat. Shape-retaining means that the stand-away annulus regains its original shape after deformation.

According to a further embodiment, the stand-away annulus is configured in the transverse direction of the deformable part as an annular cylinder on or in the deformable part. The annular cylinder can be formed in the transverse direction over a portion or over the entire width of the deformable part. As a result, a wide contact region can be provided.

According to a further embodiment, it can be provided that the protruding portion is configured as one or more ribs. A plurality of ribs here means two ribs, or three ribs, or four ribs, or five ribs, or six or more ribs. The one or more ribs can each be cuboidal in shape, preferably as a flat cuboid. Advantageously, the formation with a plurality of ribs results in the resistance rising continuously during insertion of a rod, and does not result in a sudden resistance, which improves the insertion of the rod. In a mounted arrangement of the sleeve apparatus, the one or more ribs are deformed. This is done by a rod of a headrest in the sleeve apparatus and a frame of a vehicle seat from the outside, whereby the one or more ribs are bent and thereby form a contact region in the form of a wide surface for the frame of the vehicle. The inner portion of the deformable part provides a contact surface for the rod of the headrest. Advantageously, due to the selection of the number, length, and width of the ribs, the contact region and the pressure between the rod and the frame can be adjusted in a targeted manner.

It can be provided that the one or more ribs are configured in the transverse direction over a portion or over the entire width of the deformable part, and preferably extend outwardly orthogonally to the axis of the axial passageway. The one or more ribs can be configured to be shape-retaining and elastic. Shape-retaining means that the one or more ribs regain their original shape after deformation.

It can be provided that the one or more ribs are configured in the longitudinal direction over a portion or over the entire length of the deformable part and preferably extend parallel to the axis of the axial passageway. The one or more ribs can be configured to be shape-retaining and elastic. Shape-retaining means that the one or more ribs regain their original shape after deformation.

According to a further design having a plurality of ribs, the ribs are configured to be offset from one another on the deformable part in the longitudinal direction of the deformable part. According to a further design having a plurality of ribs, it can be provided that the length of the ribs is configured to differ in their transverse direction or longitudinal direction, and preferably the length of the offset ribs decreases in the lower and distal direction of the deformable part. The contact region can thus be adjusted particularly precisely.

According to a further embodiment, it can be provided that the protruding portion is configured as one or more stand-away rings. The one or more stand-away rings are configured to lie on the deformable part, wherein the axis of the one or more stand-away rings is configured to be orthogonal to the axis of the axial passageway. Here, a plurality of stand-away rings means two stand-away rings, or three stand-away rings, or four stand-away rings, or five stand-away rings, or more stand-away rings. Advantageously, due to the configuration with a plurality of stand-away rings, the resistance can be influenced in specific regions when inserting a rod, whereby the insertion of the rod is improved. In a mounted arrangement of the sleeve apparatus, the one or more stand-away rings are deformed. This is done by a rod of a headrest in the sleeve apparatus and a frame of a vehicle seat from the outside, whereby the one or more ribs are deformed and thereby form a contact region in the form of one or more annuli for the frame of the vehicle. The inner portion of the deformable part provides a contact surface for the rod of the headrest. Advantageously, the result is that, due to the choice of the position, diameter, and thickness of the stand-away rings, the annular contact region and the pressure between the rod and the frame can be adjusted in a targeted manner.

According to an embodiment having a plurality of stand-away rings, the rings are arranged offset from one another in the longitudinal and/or transverse direction of the deformable part.

According to one embodiment, the one or more stand-away rings are configured to be shape-retaining and elastic. Shape-retaining means that the one or more stand-away rings regain their original shape after deformation.

According to a further embodiment, the deformable part comprises, preferably at its lower distal end, a second thickened portion on the inner surface of the sleeve body. The second thickened portion can be formed below or at the height of the protruding portion in order to further improve contact with a rod of a headrest.

Particularly preferably, the second thickened portion is provided when the deformable part is configured as a boom. In such an exemplary embodiment, a third recess in the sleeve body is formed between the two recesses in the longitudinal direction and connects the two recesses in the longitudinal direction. In this case, the three recesses in contact with one another can also be referred to as a U-shaped recess, which forms the boom. Due to the second thickened portion, in the mounted state, the boom is pushed outwardly towards a frame of a vehicle at its peak. Together with a protruding portion as described above, the contact between the rod and the frame can thus be optimized, and noise problems such as humming, squeaking, and rattling can be suppressed.

According to a further aspect of the present disclosure, a vehicle seat is provided, consisting of: a backrest comprising a frame having at least one opening; a sleeve apparatus according to any of the exemplary embodiments described above, wherein the sleeve apparatus is received in the at least one opening of the frame; and a headrest having at least one rod, wherein the rod is received in the inner axial passageway of the sleeve apparatus.

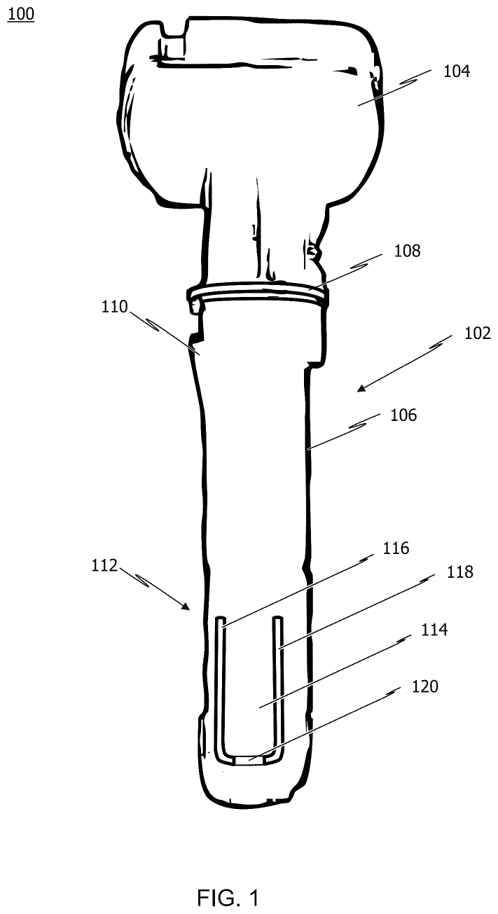

FIG. 1 is a schematic side view of a sleeve apparatus 100 according to an embodiment of the present disclosure. The sleeve apparatus 100 comprises a main body (sleeve body) 102 and a head portion 104. The head portion 104 is arranged at a proximal end of the main body 102. The main body 102 extends downwardly in the distal direction from the head part 104 and is suitable for being received in a corresponding opening of the frame of a vehicle seat (not shown). During use, the head part 104 acts as an end stop for the insertion of the sleeve apparatus into the opening of the vehicle seat. As is generally known, the head part 104 can comprise one or more locking mechanisms in order to hold the rods of the headrest in the desired position. The main body 102 of the sleeve apparatus comprises an outer surface 106 that is designed to mate with the opening of the vehicle seat when the sleeve apparatus 100 is inserted into this opening. An outer flange 108 extends circumferentially over the outer surface 106 of the main body 102. The outer flange 108 is configured to cooperate with an outer bushing that is not part of the disclosure and will not be described in further detail.

A guide rib 110 extends radially outward from the outer surface 106 of the main body 102. The guide rib 110 is configured to axially guide the main body 102 of the sleeve apparatus 100 into the frame of the vehicle seat and can act as an anti-rotation feature in order to prevent a rotation of the sleeve apparatus 100 in relation to the vehicle seat as soon as the sleeve apparatus 100 is fully installed.

A deformable part 114 is located at a distal end 112 of the main body 102. The deformable part 114 can be elastically deformed, e.g., slid into an inner axial passageway of the main body 104, when the main body 102 is inserted into the frame of the vehicle seat.

The deformable part 104 of the main body 102 is an axial strip defined by two longitudinal openings 116, 118. A first longitudinal recess 116 (or slot) is arranged on a first side of the deformable part 114. A second longitudinal recess 118 (or slot) is arranged on an opposite second side of the deformable part 114. The deformable part 114 extends between the two longitudinal recesses 116, 118. As shown in FIG. 1, the longitudinal recesses 116, 118 in this embodiment extend substantially parallel to one another. However, in some embodiments, it can also be possible to provide the recesses 116, 118 at an angle to one another and to the longitudinal direction of the main body 102. In such a case, the deformable part 114 can be substantially trapezoidal. In general, the shape of the recesses 116, 118 is not limiting for the present disclosure, as long as a deformable part 114 is provided therebetween.

The recesses 116, 118 can be produced during the injection-molding of the sleeve apparatus 100. Alternatively, the recesses 116, 118 can also be introduced later, i.e., by machining.

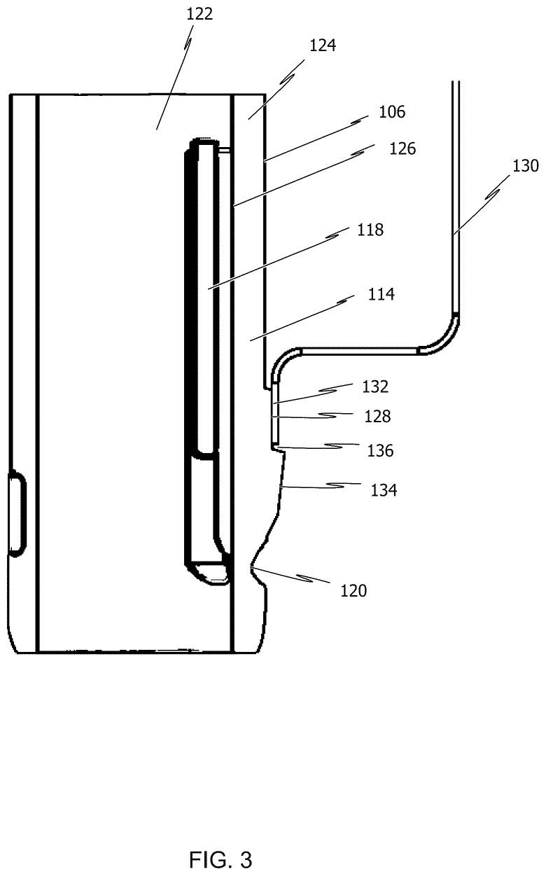

At a distal end of the recesses 116, 118, the main body 102 comprises a groove 120. The groove extends substantially circumferentially between the first and second openings 116, 118. The groove 120 connects the openings 116, 118 in the circumferential direction. As described further with reference to FIG. 3, the groove 120 can be a portion of the tubular wall of the main body 102 having a reduced wall thickness. In alternative embodiments, the groove 120 can be replaced by a third recess such that the deformable part is separated from the tubular wall at its distal end and has the shape of a boom, which can also be referred to as a cantilever.

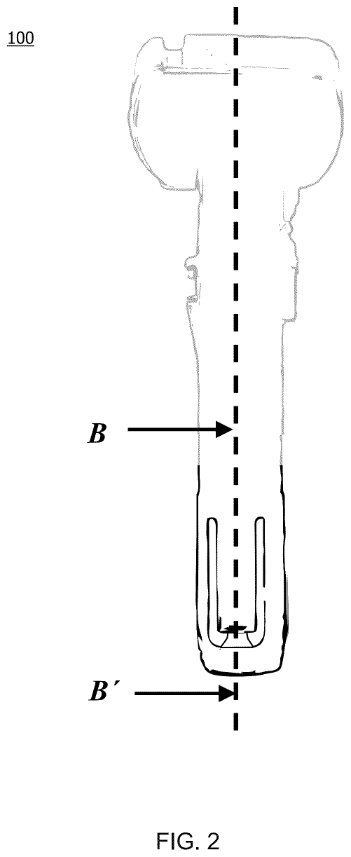

In FIG. 2, a cross-sectional line B-B can be seen, which refers to the cross-sectional view of FIG. 3. FIG. 3 shows an enlarged view of the distal end 112 according to FIG. 1 along the axis B-B′ shown in FIG. 2.

FIG. 3 schematically illustrates the deformable part 114. As already mentioned, the deformable part 114 is part of a tubular wall 124 of the main body. The tubular wall 124 comprises the aforementioned outer surface 106 and an inner surface 126. The tubular inner surface 126 defines an inner axial passageway 122 configured to receive a rod of a headrest.

FIG. 3 also shows the second longitudinal recess 118 extending between the inner surface 126 and the outer surface 106 of the tubular wall 124. At a distal end of the recesses 118 in the longitudinal direction, the groove 120 is shown, which can also be considered as a portion of the tubular wall having a reduced thickness. The groove 120 is arranged on the outer surface 106 of the tubular wall. However, in some examples, the groove 120 can also be arranged on the inner surface 126.

As can also be seen in FIG. 3, the deformable part 104 comprises a thickened portion 128. The thickened portion 128 is a portion of the deformable part having a larger diameter than the remaining outer surface 106. The thickened portion 128 has dimensions such that the deformable part 114 is pushed towards the inner axial passageway 122 when the sleeve apparatus 100 is inserted into the frame of the vehicle seat. For this purpose, the thickened portion 128 has dimensions such that it engages into the frame 130 of the vehicle seat, at least when the sleeve apparatus is fully inserted.

In the example of FIG. 3, the vehicle seat frame 130 comprises a shoulder portion 132 adapted to engage into the thickened portion 128. The outer diameter of the thickened portion 128 is slightly larger than the inner diameter of the opening formed by the shoulder portion 132 of the frame 130, so that the deformable part 114 of the sleeve apparatus is forced into the inner axial passageway 122 when the sleeve apparatus is fully inserted into the frame 130. The thus deformed portion 114 can produce a friction fit not only between the frame 130 and the main body, but also between the main body and the rod of the headrest (not shown).

The deformable part 114 also comprises a projection 134. The projection 134 projects beyond the thickened portion 128. The projection 134 is substantially ramp-like in form. The thickness of the ramp increases gradually from a distal end of the deformable part 114 towards a proximal end (i.e., in the direction of the thickened portion 128). Between the projection 134 and the thickened portion 128, the deformable part comprises a shoulder portion 136. The shoulder portion 136 acts as a safety stop or end stop and prevents the sleeve apparatus 100 from being undesirably pulled out of the opening of the frame 130, in particular when the rod of the headrest is inserted into the axial passageway 122. To disengage the sleeve apparatus from the frame 130, the rods of the headrest must be removed from the inner axial passageway 122, and the deformable part 114 must be pushed further into the inner axial passageway 122 until the shoulder portion 136 is free from a corresponding recess of the frame 130. In the embodiment of FIG. 3, the recess of the frame 130 is formed by a distal end of the shoulder portion 132.

The projection 134 of the deformable part latches into a recess of the frame 130 as soon as the sleeve apparatus has been fully inserted into the opening of the frame 130. During insertion, the deformable part 114 is gradually pushed further into the inner axial passageway 122 while the ramp-shaped projection 134 slides past the frame, in particular the shoulder portion 132. As soon as the sleeve apparatus is fully inserted, the deformable part 114 can snap back to a certain degree such that the shoulder portion 136 of the projection 134 can be received in the aforementioned recess.

As already mentioned, the sleeve apparatus of the present disclosure is preferably a one-piece, injection-molded plastic part, so that the sleeve apparatus can be produced in a single production step. An overmolding, or other additive manufacturing steps, are not required.

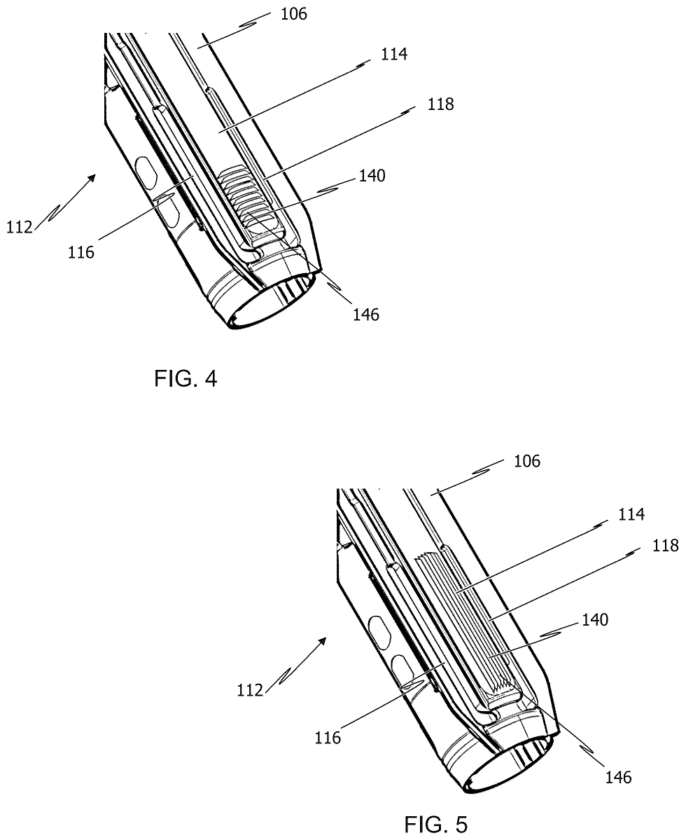

FIG. 4 and FIG. 5 each show an enlarged view of the distal end 112 of the sleeve apparatus according to FIG. 1.

The exemplary embodiments of FIG. 4 and FIG. 5 differ from the exemplary embodiment of FIG. 1 in that a protruding portion 140 is configured on the deformable part 114, which is formed by the two openings 116 and 118 as an axial strip in the longitudinal direction.

The protruding portion 140 of FIG. 4 and FIG. 5 can be formed in lieu of the thickened portion 128 of FIG. 3. In this case, the protruding portion 140 can also perform the functions of the thickened portion 128 as described above. The protruding portion 140 is a portion of the deformable part that projects beyond the diameter of the outer surface 106. The protruding portion 140 has dimensions such that the deformable part 114 is pushed towards the inner axial passageway 122 when the sleeve apparatus 100 is inserted into the frame of the vehicle seat. For this purpose, the protruding portion 140 has dimensions such that it engages into the frame 130 of the vehicle seat, at least when the sleeve apparatus is fully inserted. The deformable part 114 with the protruding portion 140 thus forms a contact region between the rod of the headrest and the frame of the vehicle seat, thereby suppressing noise problems such as humming, squeaking, and rattling, while simultaneously minimizing difficulty in adjusting the headrest through the arrangement of the protruding portion in the lower region of the sleeve apparatus.

In the exemplary embodiments of FIG. 4 and FIG. 5, the protruding portion 140 is formed from a plurality of ribs 146 that are offset parallel to one another.

In FIG. 4, the plurality of ribs 146 are configured as a plurality of outwardly stand-away flat cuboids in the transverse direction across approximately the entire width of the deformable part 114. In this exemplary embodiment, 10 ribs 146 are formed at the lower end of the deformable part 114.

In FIG. 5, the plurality of ribs 146 are formed as a plurality of outwardly stand-away flat cuboids in the longitudinal direction over approximately the entire length of the deformable part 114. In this embodiment, the protruding portion 140 is formed from six ribs 146 that are offset parallel to one another.

The ribs 146 of the exemplary embodiments of FIG. 4 and FIG. 5 cooperate with a shoulder portion 132 of the vehicle seat frame 130 (not shown in FIG. 4 and FIG. 5). The outer diameter of the protruding portion 140 is slightly larger than the inner diameter of the opening formed by the shoulder portion 132 of the frame 130, so that the deformable part 114 of the sleeve apparatus is forced into the inner axial passageway 122 when the sleeve apparatus is fully inserted into the frame 130. The thus deformed portion 114 can produce a friction fit not only between the frame 130 and the main body, but also between the main body and the rod of the headrest (not shown).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

100 Sleeve apparatus
102 Main body
104 Head portion
106 Outer surface
108 Flange
110 Guide rib
112 End of main body
114 Deformable part of main body
116 First recess in longitudinal direction
118 Second recess in longitudinal direction
120 Groove
122 Axial passageway
124 Tubular wall
126 Inner surface
128 Thickening portion
130 Vehicle seat frame/Frame of vehicle seat
132 Shoulder portion
134 Projection
136 Shoulder portion
140 Protruding portion
146 Rib

What is claimed is:

1. A sleeve apparatus (100) for a headrest, comprising a sleeve body (102) for insertion into a frame of a vehicle seat, wherein, during use, the sleeve body (102) is inserted into the frame of the vehicle seat and is generally located therein,
wherein the sleeve body (102) comprises a tubular wall (124) defining an inner axial passageway (122) having an inner surface (126) configured to receive a rod of a headrest,
wherein the tubular wall (124) comprises an outer surface (106) opposite the inner surface (126) of the tubular wall (124), and
wherein the tubular wall (124) comprises at least two recesses (116, 118)
extending in a longitudinal direction of the tubular wall (124) between the outer surface (106) and the inner surface (126), wherein the recesses (116, 118) define a deformable part (114) of the tubular wall (124) of the sleeve apparatus (100).

2. The sleeve apparatus (100) according to claim 1, wherein the two recesses (116, 118) are configured to be substantially parallel to one another, or wherein the two recesses (116, 118) are configured to lie at an angle to one another and to the longitudinal direction of the sleeve body.

3. The sleeve apparatus (100) according to claim 1, wherein the two recesses (116, 118) are configured to be L-shaped.

4. The sleeve apparatus (100) according to claim 1, wherein the tubular wall (124) comprises at least one groove (120) extending substantially perpendicular to the parallel recesses (116, 118), wherein the groove (120) connects the recesses (116, 118) to one another.

5. The sleeve apparatus (100) according to claim 1, wherein the groove (120) is a part of the tubular wall (124) having a reduced wall thickness.

6. The sleeve apparatus (100) according to claim 1, wherein the two recesses (116, 118) are configured to be L-shaped and the L-shaped peaks of the two recesses (116, 118) are preferably conjugate with one another, and/or the L-shaped peaks are preferably formed in the lower (distal) region of the recesses (116, 118).

7. The sleeve apparatus (100) according to claim 1, wherein the sleeve apparatus (100) is a one-piece injection-molded part, and/or
wherein the sleeve apparatus (100) does not comprise over-molded parts.

8. The sleeve apparatus (100) according to claim 1, wherein the deformable part (114) comprises a thickened portion (128) configured to contact the frame (130) of the vehicle seat.

9. The sleeve apparatus (100) according to claim 1, wherein the thickened portion (128) of the deformable part (114) has dimensions such that the deformable part (114) is pushed towards the inner axial passageway (122) when the sleeve apparatus (100) is inserted into the frame (130) of the vehicle seat.

10. The sleeve apparatus (100) according to claim 1, wherein the deformable part (114) comprises a projection (134) extending across the outer surface (106) of the tubular wall (124), wherein the projection (134) defines a latch that is suitable for securing the sleeve apparatus (100) within the frame (130) of the vehicle seat, in particular in a longitudinal direction of the sleeve apparatus (100).

11. The sleeve apparatus (100) according to claim 10, wherein the projection (134) is substantially ramp-like in form, and its thickness increases gradually from a distal end of the deformable part (114) towards a proximal end of the deformable part (114), wherein the projection (134) defines a shoulder portion (132) for engagement into a recess of the frame (130) of the vehicle seat when it is in use.

12. The sleeve apparatus (100) according to claim 1, wherein the deformable part (114) comprises a protruding portion (140), preferably lower region of the deformable part (114), which is preferably configured to extend beyond the outer surface (106) when a rod of a headrest is arranged in the sleeve apparatus (100) and cooperates with a frame of a vehicle seat.

13. The sleeve apparatus (100) according to claim 12, wherein the protruding portion (140) is configured to not extend beyond the outer surface (106) when no rod of a headrest is arranged in the sleeve apparatus (100), preferably in that the protruding portion (140) is arranged in an inwardly offset manner on the deformable part (114), preferably in a groove in the deformable part (114).

14. The sleeve apparatus (100) according to claim 12, wherein the protruding portion (140) is formed integrally in or on the deformable part, and preferably the sleeve apparatus (100) having the deformable part (114) with the protruding portion (140) is a one-piece injection-molded part.

15. The sleeve apparatus (100) according to claim 12, wherein the protruding portion (140) is configured as a stand-away annulus (142) having an opening (144), preferably being configured as a semicircular annular segment or three-quarter annular segment, wherein the opening (144) is preferably configured as a slot in the stand-away annulus (142) or missing annular segment.

16. The sleeve apparatus (100) according to claim 15, wherein the opening (144) is formed outwardly, and the stand-away annulus (142) is preferably configured to be shape-retaining and elastic.

17. The sleeve apparatus (100) according to claim 15, wherein, in the transverse direction of the deformable part (114), the stand-away annulus (142) is configured as an annular cylinder at or in the deformable part (114), and preferably wherein the annular cylinder is configured in the transverse direction over a portion or over the entire width of the deformable part (114).

18. The sleeve apparatus (100) according to claim 12, wherein the protruding portion (140) is configured as one or more ribs (146), wherein the one or more ribs (146) are preferably each cuboidal in shape.

19. The sleeve apparatus (100) according to claim 18, wherein the one or more ribs (146) are configured in the transverse direction over a portion or over the entire width of the deformable part (114), and preferably extend outwardly orthogonally to the axis of the axial passageway (122), or wherein the one or more ribs are configured in the longitudinal direction over a portion or over the entire length of the deformable part and preferably extend parallel to the axis of the axial passageway.

20. The sleeve apparatus (100) according to claim 18,
wherein the plurality of ribs (146) are configured to be offset from one another on the deformable part (114) in the longitudinal direction of the deformable part (114), and/or wherein the length of the ribs (146) is configured to differ in their transverse direction, and preferably the length of the offset ribs (146) decreases in the lower, or distal, direction of the deformable part (114).
